(19) United States
(12) Patent Application Publication
(10) Pub. No.: US 2026/0111403 A1
(43) Pub. Date: Apr. 23, 2026

(54) Z/OS Mapping of SMF Records to System Entities

(71) Applicant: Teracloud ApS, Copenhagen K (DK)

(72) Inventors: Michael Barrett-Lennard, Perth (AU); Mik Clarke, Perth (AU)

(73) Assignee: Teracloud ApS, Copenhagen K (DK)

(21) Appl. No.: 19/366,232

(22) Filed: Oct. 22, 2025

Related U.S. Application Data
(60) Provisional application No. 63/710,265, filed on Oct. 22, 2024.

(51) Int. Cl. G06F 16/22; G06F 16/28

(52) U.S. Cl. CPC G06F 16/2228; G06F 16/288

(57) ABSTRACT

A system for mapping System Management Facility (SMF) records to logical entities includes a processor, a storage accessible by the processor, and a mapping program that, when executed by the processor, causes the system to receive SMF records that contain information about events that occur in the system, determine correlation data between the events and related logical entities, generate a plurality of unique keys, associate each of the generated plurality of unique keys with a corresponding logical entity of the related logical entities, store, in a relational database in the storage, each of the logical entities associated with the associated unique key of the plurality of unique keys corresponding to each logical entity, and generate a report, or perform interactive statistical analyses.

### RELATED APPLICATION

This application claims priority to U.S. Patent Application 63/710,265 filed in the United States on Oct. 22, 2024, the entire content of the prior application is hereby incorporated by reference.

### FIELD

The present invention relates to a computer-implemented method and system for automated analysis of computer traces or metrics, and more specifically, to correlating System Management Facility (SMF) activity records produced by IBM z/Architecture mainframe computers running the IBM z/OS® Operating System (OS) to logical system entities within a mainframe computing environment.

### BACKGROUND

Mainframe computing is a computing platform used today by the largest companies in the world. A mainframe often processes many workloads such as accounts receivable, general ledger, payroll and a variety of applications needed for specific business requirements. These workloads are commonly referred to as applications or jobs.

A mainframe is a complex environment consisting of databases and datasets (i.e., files). These data typically reside on a direct access storage device (DASD) or disk drive. In addition to DASD, mainframe applications also rely on one or more tape drives/devices to store portions of these data. Tape drive(s) can be the primary repository of vital information within a mainframe application. Tape today can be either physical tape which must be mounted on hardware to be read or virtual tape which is disk-based storage emulating physical tape.

Mainframe computers process information in one of two modes of operation, online or batch. An online system, for example, provides an interactive application interface for interaction by customers and employees. In contrast, a batch system, for example, involves non-interactive processing of an application (e.g., generating statements) in which the application is started and runs without intervention until the process is completed. Both batch and online applications exist and run in predetermined cycles to automate data processing for an organization.

As a mainframe environment processes applications, event log entries are created. Each event log entry provides detailed information regarding a particular event (e.g., job initiation, dataset open, dataset close, job termination, etc.). The detailed information includes, for example, a time the event occurred, a type of the event, a status of the event, and/or other information related to the event. A system management facility (SMF) is responsible for generating and managing these event log entries. As such, event log entries are referred to as SMF records. Event log entries (e.g., SMF records), in one example, are utilized by one or more other processes executing within the mainframe environment as a way to manage the performance of the mainframe environment.

IBM z Batch Resiliency (IZBR) currently works with multiple event-based Virtual Storage Access Method (VSAM) datasets, the TimeLiner DataSpace and 3D Virtual Katalog (probably at least 1 more VSAM Dataset). When it wants to produce a report, it is necessary for it to go through the lengthy (and often complex) process of correlating events from all of these different databases in order to discover what happened at a given point in the past. This makes reports difficult to write and slow to display.

There are several products that process SMF records in the market. However, they are all geared towards extracting and presenting performance- and/or capacity-related metrics from the SMF records. None of these products is able to tell the “story” of a job and describe everything that is done to the extent that it can be used to reliably formulate corrective recovery actions should a failure be identified.

For example, the IBM Z® Performance and Capacity Analytics enables users to effectively manage the performance of their system by collecting performance data in a Db2® database and presenting the data in a variety of formats for use in systems management.

IntelliMagic Vision empowers mainframe sites to prevent service disruptions before they occur and utilize measurement data insights to lower costs and optimize business applications.

Precisely's Ironstream can be used to simplify SMF data and forward the information to analytics platforms, such as Splunk, ServiceNow, and others, where a Batch Job Monitor is used to determine if service levels are being met for the execution of critical jobs within their daily batch window.

IBM® SMF Explorer is a Python framework configured to access SMF data directly from dump data sets. The framework uses the z/OS® Data Gatherer: SMF Data REST Services to fetch data from a z/OS host. IBM SMF Explorer is a Python library that can be used to write scripts, embed it into other applications, or just fetch data interactively. Additionally, the Python ecosystem provides access to a large set of libraries for visualization, data analysis, machine learning, etc. The framework enables SMF data record fetching, provides information on selected SMF fields, and serves chunks of SMF data, suitable for different analysis types, that can be selected for further processing. For various SMF records and subtypes, sets of SMF fields are provided to make getting relevant data even easier (e.g., system utilization, LPAR utilization, cache statistics, etc.).

BMC AMI Ops Automation for Batch ThruPut is a software product that improves batch throughput, manages workload service goals (SLAs), and optimizes resource utilization (primarily CPU), while honoring datacenter-specific workload constraints.

EasySMF makes the information in the z/OS SMF data accessible and easy to use. EasySMF provides access to the most common and useful SMF information without programming and without expensive additional software, such as SAS, for example. EasySMF allows users to relate data from different SMF records from the same time period. For example, data from RMF records shows resource utilization, while type 30 records show what was actually running at that time. With EasySMF, users can switch quickly between reports and investigate the relationships between them. Data is downloaded and stored locally on the PC, so that users can interact directly with the reports, change time frames, report parameters, or drill through to see more detail. Valuable mainframe CPU cycles are conserved for business processing rather than system management.

Spectrum Writer allows users to create production reports fast, run one-time queries quickly and easily, and extract and format their product's mainframe data for use in PC spreadsheet, database and graphics programs, Oracle databases, Unix Web servers, Internet and Intranet Web browsers (HTML), and/or any other mainframe-, mini-, or PC-application that requires a custom file format.

There are several products that are Batch Schedulers for the z/OS system. They go down to the level of detail where a job containing multiple steps has been submitted and either all the steps are executed successfully or one of them has failed, and thus the job is considered to have failed. Selective restart from a specific step and giving the user a list of the dataset that references a specific step (e.g., from the failed jobs JCL job log) is about as far as these products go. None of the currently available products track the datasets used by executing jobs from SMF records.

IZBR seeks to track the flow of data through each customer's batch processing, enabling it to work out the steps needed to recover a customer's batch run following the discovery of a non-obvious data error. Obvious data errors cause the batch job processing the data to end in error. Non-obvious data errors do not cause the batch job processing the data to end in error, which allows subsequent batch jobs to run, consuming the potentially erroneous output from the first batch job. It is, therefore, desirable for IZBR to track the life cycle of individual dataset instances so it can trace the path of the data going in and out of them.

### SUMMARY

The following presents a simplified summary of the invention in order to provide a basic understanding of some example aspects of the invention. This summary is not an extensive overview of the invention. Moreover, this summary is not intended to identify critical elements of the invention or to delineate the scope of the invention.

An exemplary system for mapping System Management Facility (SMF) records to logical entities is disclosed. The system comprising: a processor; memory storing instructions for mapping System Management Facility (SMF) records to logical entities, the instructions causing the processor to be configured to: receive plural SMF records, each SMF record including data associated with a system event; update plural logical entities with the system event data, each logical entity being configured to store data with plural logical entities; generate, as one or more of the plural logical entities is being updated with the system event data, a at least one unique key using system event data common to at least two of the plural logical entities; associate the at least one unique key with each logical entity that includes the system event data used to generate the at least one unique key; store, in a relational database, correlations between the plural logical entities based on the at least one unique key, and dynamically adjusting at least one data record of the plural logic entities and data associations based on content of a received SMF record.

An exemplary computer-implemented method for mapping System Management Facility (SMF) records to logical entities is disclosed, the method comprising: storing, in memory of a computer, instructions for mapping SMF records to logical entities; executing, by a processor of the computer, the instructions stored in memory, the instructions causing the processor to perform the steps of: receiving plural SMF records, each SMF record including data associated with a system event; updating plural logical entities with the system event data, each logical entity being configured to store data with plural logical entities; generating, as one or more of the plural logical entities is being updated with the system event data, a at least one unique key using system event data common to at least two of the plural logical entities; associating the at least one unique key with each logical entity that includes the system event data used to generate the at least one unique key; storing, in a relational database, correlations between the plural logical entities based on the at least one unique key, and dynamically adjusting at least one of attributes of the plural logic entities and data associations based on content of a received SMF record.

An exemplary non-transitory computer readable medium is disclosed, the medium storing instructions which causes a computer system to be configured to: receive plural SMF records, each SMF record including data associated with a system event; update plural logical entities with the system event data, each logical entity being configured to store data with plural logical entities; generate, as one or more of the plural logical entities is being updated with the system event data, a at least one unique key using system event data common to at least two of the plural logical entities; associate the at least one unique key with each logical entity that includes the system event data used to generate the at least one unique key; store, in a relational database, correlations between the plural logical entities based on the at least one unique key, and dynamically adjusting at least one of attributes of the plural logic entities and data associations based on content of a received SMF record.

### BRIEF DESCRIPTION OF THE FIGURES

Some implementations are best understood from the following detailed description when read in conjunction with the following figures.

FIG. 1 illustrates an exemplary system according to an aspect of the invention.

FIG. 2 illustrates an exemplary diagram of an analysis of a job failure, according to an aspect of the invention.

FIG. 3 illustrates an exemplary diagram of performing a recovery after a failed job, according to an aspect of the invention.

FIG. 4 illustrates an exemplary diagram of a 3D Catalog including information about datasets at different points in time, according to an aspect of the invention.

FIG. 5 is a diagram of an exemplary Entity Relationship (ER) of entities, according to an aspect of the invention.

FIG. 6 illustrates a method for mapping SMF records to logical entities according to an aspect of the invention.

FIG. 7 is a first method for dynamically updating a data record of a logical entity according to an aspect of the invention.

FIG. 8 is a second method for dynamically updating a data record of a logical entity according to an aspect of the invention.

FIG. 9 is a third method for dynamically updating a data record of a logical entity according to an aspect of the invention.

FIG. 10 is a fourth method for dynamically updating a data record of a logical entity according to an aspect of the invention.

FIG. 11 is a functional block diagram of an exemplary server and/or a mainframe according to an aspect of the invention.

FIG. 12 is a functional block diagram of an exemplary personal computer or other workstation or terminal device according to an aspect of the invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The invention will now be described by reference to exemplary embodiments and variations of those embodiments. Although the invention is illustrated and described herein with reference to specific embodiments, the illustrated examples are not intended to be limited to the details shown and described. Rather, various modifications may be made in the details within the scope and range of equivalents of the claims and without departing from the invention. For example, one or more aspects of the disclosed embodiments can be utilized in other embodiments and even other types of devices. Moreover, certain terminology is used herein for convenience only and is not to be taken as a limitation.

SMF records contain information about events that occur on a z/OS system. z/OS entities, such as jobs (e.g., a task or a series of tasks that can be executed without user intervention), steps, datasets, and activities, for example, are known parts of a z/OS system. It is difficult to get a picture of the system entities to which these events relate because parts of the information are contained in different SMF records that are generated at different times while the entity is active.

This is particularly important with datasets. Normally, SMF processing systems can record the events associated with the datasets. SMF processing systems, however, do not collate these events into a single dataset record. This makes discovering the state of a dataset at a particular time difficult.

The exemplary embodiments described herein is a rework and extension of IZBRs event-based data stores to fit inside a relational database and to make it easier to track down which datasets have been used by which job by correlating them as the data is collected, so that the resulting database is full of meaningful relationships rather than uncorrelated events. The benefit of this process is that it makes discovery much easier as the complex correlation process does not have to be performed every time the data is queried. It also allows a much more accurate ‘instance id’ keyed correlation mechanism to be used, as opposed to the current ‘dataset name’ keyed correlation mechanism.

Exemplary embodiments of the present disclosure can enable the migration of IZBR away from VSAM datasets and into a relational database. Further, the described embodiments can significantly reduce the complexity of producing new IZBR reports and reengineering existing reports to draw data from the relational database. As a result, the storing and indexing of data is significantly enhanced in the relational model such that data interpretation is simpler and faster than current or known solutions.

According to an embodiment of the present disclosure, a computing system can be configured to perform operations for mapping information in existing SMF records to logical entities, such as jobs, steps, events, and datasets, for example. As will be described in greater detail, the computing system can generate unique keys during the mapping operation for linking the logical entities. As a result, the logical entities can be stored as persistent data (e.g., stored for later retrieval and use) in a database.

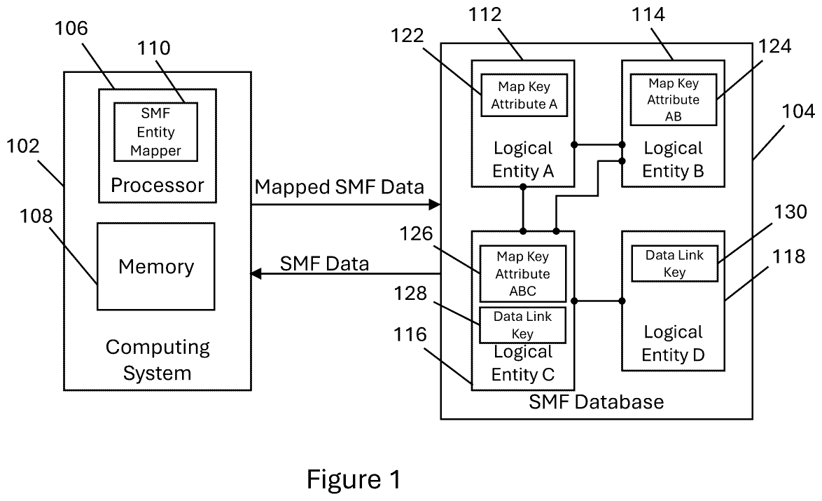

FIG. 1 illustrates a system for processing SMF records according to an exemplary embodiment. As shown in FIG. 1, the system includes a computing system 102 and a database 104. The computing system can include a processor 106 and memory 108. The memory 108 can be configured to store instructions that can be executed by the processor 106 for performing the operations of a SMF Entity Mapper 110. The SMF Entity Mapper 110 enables the processor 106 to map the information in existing SMF records to logical entities.

IZBR supports analysis of job and dataset information to help recover from failures. Non-limiting and non-exclusive examples of problems that can be solved by the IZBR product can include:

### Example 1: Analysis of a Job Failure

When a job fails, the method described herein can determine which job failed or which dataset contains invalid data. What needs to be determined is what was the root cause of the problem. The method described herein performs a so-called reverse cascade to backtrack through time to see what other jobs or datasets could have impacted the failed job.

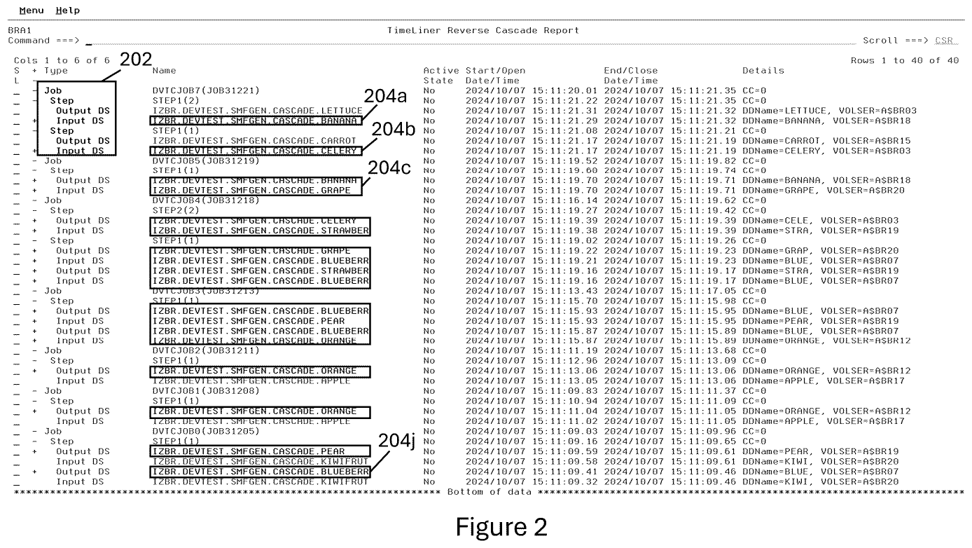

For example, FIG. 2 illustrates a screen shot 200, in which the failed job is shown as 202, and all jobs that impacted the failed job 202 are listed underneath the failed job 202. Datasets shown as 204a-204j (not all of which are labeled for clarity but correspond sequentially to each box outlined between the labeled end points 204a and 204j) relate to previous jobs impacted by the current job.

### Example 2: Perform a Recovery

After the failed job or dataset is determined, it is desirable to know what jobs needs to be rerun to get back to what the method had. The method described herein performs a so-called forward cascade to determine impacted jobs and datasets going forward in time.

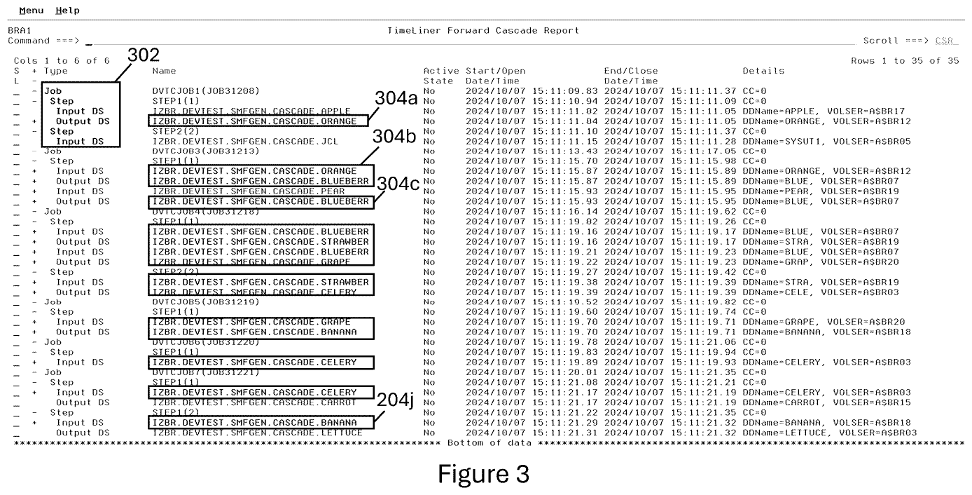

For example, FIG. 3 illustrates a screen shot 300, in which the root cause job is shown as 302, and below it are shown the jobs that were impacted by the root cause job 302. Datasets shown as 304a-304j (not all of which are labeled for clarity but correspond sequentially to each box outlined between the labeled end points 304a and 304j) relate to subsequent jobs impacted by the current job.

### Example 3: 3D Catalog

Current disk hardware supports taking a snapshot of all volumes at a certain point in time. This allows an organization to recover all volumes in the event of catastrophic loss. It would not allow the recovery of individual datasets from the volumes, since the contents of the volumes at each point in time is unknown. The method described herein allow storing information about datasets at all points in time.

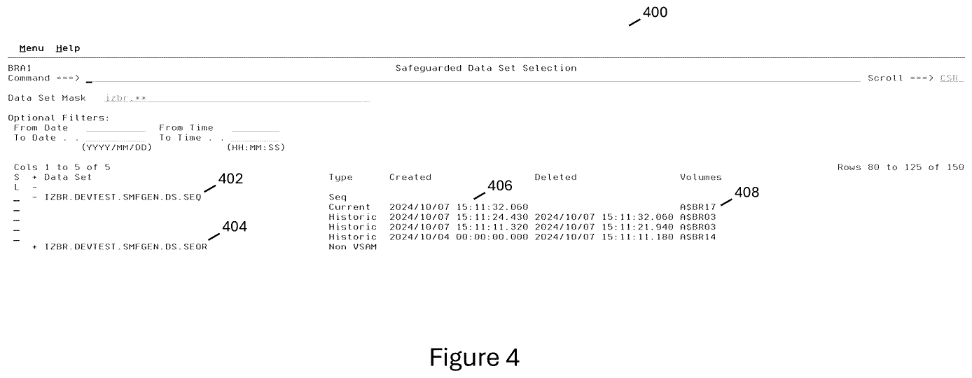

For example, FIG. 4 illustrates a screen shot 400, in which information about datasets 402, 404 from all points in time is shown. One dataset IZBR.DEVTEST.SMFGEN.DS.SEQ 402 has been expanded to show the time intervals 406 when the dataset existed and what volumes 408 it was on.

As shown in FIG. 1, a z/OS database can include one or more logical entities 112, 114, 116, 118 which represent a business concept or real-world classification of objects or events about which an organization collects and stores data. It is a component of a logical data model, which defines the business's information requirements before the physical database structure is implemented. According to an embodiment of the present disclosure, the entities can include Job, Step, Event Dataset. While the processor 106 of FIG. 1 uses and/or generates four logical entities, it should be understood that the number of logical entities can be any number suitable for mapping the SMF records as desired. The processor 106 can be configured to store the logical entities 112, 114, 116, 118 data in the database 104 so that the entities and the data associated therewith persists and remains available and accessible when Z/OS is closed or the system 100 is powered down.

As shown in FIG. 1, the processor 106 is configured to generate Mapped SMF Data 120, which includes the logical entities 112, 114, 116, 118 and one or more unique keys 122, 124, 126 which are used to reliably associate the logical entities. Each logical entity can include one or more attributes that define its properties or characteristics. The processor 106 can generate the unique keys 122, 124, 126 based on the attributes that are common across two or more of the logical entities.

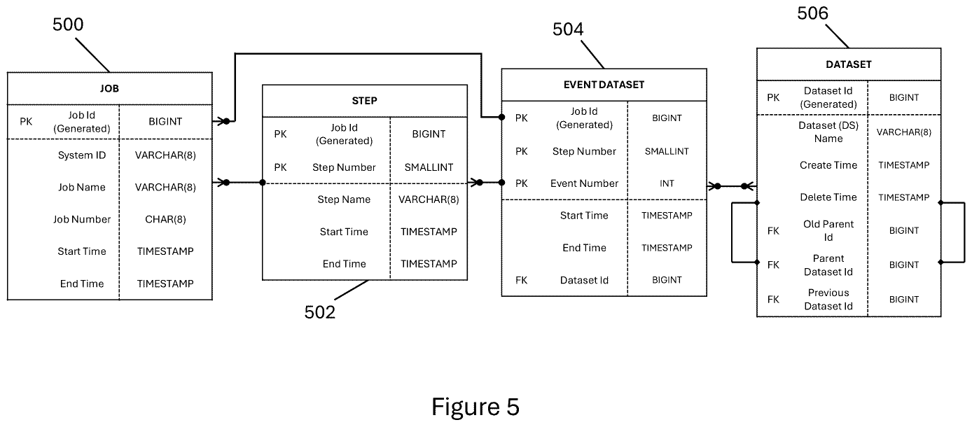

FIG. 5 is a diagram of an exemplary Entity Relationship (ER) of entities, according to an aspect of the invention. FIG. 5 illustrates the mapping of information in existing SMF records can be performed in association with logical or persisted entities. As shown in FIG. 5, the processor 106 generates a Job Logical Entity 500, a Step Logical Entity 502, an Event Dataset Logical Entity 504, and Dataset Logical Entity 506. The Job Logical Entity 500 can represent a complete, executable unit of work submitted by a user. Each Job Logical Entity 500 can be a container for running one or more programs in a specific sequence, along with the data and resources needed by the programs to execute. The Step Logical Entity 502 is related to the Job Logical Entity 500 and represents the execution of a single program or procedure in the batch job. The Event Dataset Logical Entity 504 is related to both the Job Logical Entity 500 and the Step Logical Entity 502 and includes a grouping of events related to the batch job and steps performed in the execution of the batch job that have been collected for later analysis. The Dataset Logical Entity 506 is related to the other logical entities 500, 502, 504, and identifies the source of an event that triggers other related events or “child” events in associated defined by the batch job of the Job Logical Entity 500. According to an exemplary embodiment, the Dataset Logical Entity 506 can be implemented as a Virtual Storage Access Method or a Generation Data Group, partitioned, or sequential dataset.

Each logical entity 500, 502, 504, 506 includes plural attributes, where each attribute is defined by an integer value, a character value, a timestamp or any other suitable value as desired or as defined by the Z/OS. In one example, the Job Logical Entity 500 can include attributes Job ID, System ID, Job Name, Job Number, Start Time, and End Time, or any other suitable attribute as desired. The Step Logical Entity 502 can include the attributes Job Id, Step Number, Step Name, Start Time, and End Time or any other suitable attribute as desired. The Event Dataset Logical Entity 504 can include the attributes Job Id, Step Number, Event Number, Start Time, End Time, and Dataset Id. The Dataset Logical Entity 506 can include the attributes Dataset Id, Dataset Name, Create Name, Delete Time, Old Parent ID, Dataset Id, Previous Dataset Id, or any other suitable attribute as desired.

The processor 106 can establish an association between the logical entities as follows:
Job Logical Entity 500->Step Logical Entity 502
Job Logical Entity 500->Event Dataset Logical Entity 504
Step Logical Entity 502->Event Dataset Logical Entity 504
Event Dataset Logical Entity 504->Dataset Logical Entity 506
Dataset 506->Event Dataset 504
Dataset 506->Dataset 506 (parent-child relationship)

The processor 106 can be further configured to map the logical entities by generating the unique keys 112, 114, 116, 118. The generation of the unique keys establishes a reliable association between the logical entities. As shown in Table 1, the attributes common (italicized and underlined) across the logical entities 500, 502, 504, 506 can include the following:

```
Job Logical Entity 500 Attributes:
  Job Id (Generated)
  Sys Id
  Job Name
  Job Number
  Start Time
  End Time
  (Other job information)
Step 502 Attributes:
  Job Id (Generated)
  Step Number
  Step Name
  Start Time
  End Time
  (Other step information)
Event Dataset 504 Attributes:
  Job Id
  Step Number
  Event Number
  Start Time
  End Time
  Dataset Id (Generated)
  (Other dataset event
  information)
Dataset 506 Attributes:
  Dataset Id (Generated)
  Dataset (DS) Name
  Create Time
  Delete Time
  **Parent Id (references VSAM
  Cluster or GDG Base)
  **Old Parent Id (references
  VSAM Cluster or GDG Base)
  **Previous Dataset Id
  (Other dataset information)
```

As shown in Table 1, the Dataset Id is a common attribute of the Event Dataset Logical Entity 504 and the Dataset Logical Entity 506. The Dataset ID serves as both a primary key for reliably linking the two logical entities and also services as a foreign key for linking specific attributes of the two logical entities. For example, as a foreign key the Dataset Id of the Event Dataset Logical Entity 504 is directly linked to the attributes Old Parent Id, Dataset Id, and Previous Dataset Id of the Dataset Logical Entity 506. As a result, the Dataset Id is effectively cross-referenced to the past and current identification values associated with the Event Dataset.

According to an embodiment, the processor 104 can determine whether each logical entity is active based on whether information relevant to the entity is in the process of being updated using the SMF records. For example, the processor 106 can determine that the Job Logical Entity 500 is active when a batch job is currently running. The processor 106 can determine that the Step Logical Entity 502 is active when a step associated with the batch job is currently running. The processor 106 can determine that the Event Dataset Logical Entity is active when the event data associated with the batch job of the Job Logical Entity 500 and/or the step of the Step Logical Entity is open. Still further, the processor 106 can determine that the Dataset Logical Entity is active when the Dataset is present or exists on the system.

The processor 106 is configured to use the unique keys to determine whether a logical entity is active. For example, using the unique keys the processor 106 can track active entities in keyed maps. According to an exemplary embodiment, the processor 106 can track the active jobs and active events using attributes as shown in Table 2.

TABLE 2

ActiveJobMap
Key
Sys Id,
Job Name
Values
JobId (Generated)
Current Step Number
Step Created
ActiveEventDatasetMap
Key
DataSet Name
Values
DatasetId (Generated)

Once the primary key is generated, the processor 106 can use the primary key (PK) to look up the generated key for the mapped logical entities and update each logical associated logical entity with new information from the SMF record. If the entity does not exist, the processor 106 can create a new logical entity that is updated with the SMF information. For example, as shown in FIG. 4, the primary key is associated with the generated attribute Job Id. As a result, the logical entities 500, 502, 504, and 506, which are mapped via the Job ID attribute can be updated with the new information from the SMF record.

The processor 106 can update entries in the maps and store the updated information when a logical entity is active. The processor 106 receive SMF information from the database, which notifies the processor 106 when a logical entity is no longer active. The processor 106 can disable or remove the mapping between logical entities of a mapped grouped when the SMF information for one of the logical entities is received. According to an exemplary embodiment, the SMF record for the logical entities of FIG. 4 can include those shown in Table 3.

TABLE 3

```
Job - (SMF 30 sub type 5)
Step - (SMF 30 sub type 4)
  Dataset - (SMF 14,
  15, 61, 64, 65, 66)
Event - (SMF 14,15, 64)
```

According to an exemplary embodiment, the processor 106 can use the Parent Id attribute of the Dataset Logical Entity 506, to track VSAM Cluster to VSAM Component associations, GDG Base to GDG part associations, or any other suitable data cluster to component association as desired. SMF records that keep track of these associations can be different from SMF records that give information about the datasets. When the processor 106 receives a record relating to a parent association, it checks whether the parent id has already been set, and if not, the processor 106 can update the parent relationship for that dataset.

According to another exemplary embodiment, the processor 106 can receive an SMF 66 record that indicates a rename or move. As shown in FIG. 4, when the SMF 66 record is received, the processor 106 can update the delete time of the dataset record to the time of the SMF record and create a new dataset record with create time set to the SMF Record time. The processor 106 can then set the Previous Dataset Id of the new record to the original Dataset Id. As a result of these operations, the processor 106 keep track of renames and volume movements.

According to exemplary embodiment, the processor 106 can receive an SMF 66 record represents a dataset rename for a VSAM. As already discussed, the processor 106 can record dataset renames by creating a new dataset record and setting the Delete Time of the original dataset record. However, because each part of a VSAM generates a different SMF record, the processor 106 handles VSAM renames differently. For example, if the processor 106 is to rename a VSAM of a Keyed Sequence Data Set (KSDS) and its components, the processor 106 will receive three SMF 66 records for the cluster, index, and data parts of the dataset. The processor 106 can change the order of the records from the sequence in which they were received depending on how the processor 106 renames the VSAM. According to an exemplary embodiment, to the processor 106 can be configured to only rename parts of the VSAM.

The processor 106 can be configured to change Parent Id in the Dataset Logical Entity 106 which changes the VSAM cluster to VSAM component association.

According to an exemplary embodiment, the processor 106 can rename a VSAM by first renaming the VSAM cluster. For this operation, the processor 106 Creates a new cluster dataset record, sets the delete time of the original cluster record, and points the existing components at this new parent. To rename the component, the processor 106 can be configured to create a new component record, set the delete time of the original component record, and point the new component at the new parent.

By renaming the cluster and the component, the processor 106 can establish proper associations for the data. Once the VSAM component is renamed both old and new components are pointing at the same new cluster. The processor 106 adds a new field (OldParentId) to the Dataset Logic Entity 506 so that the original VSAM component points back to the original VSAM cluster. For example, the processor performs an operation to rename the VSAM cluster by creating a new cluster dataset record, setting the delete time of the original cluster record, pointing the existing components at this new parent, and recording OldParentId in the Dataset Logic Entity 406. Next, the processor 106 renames the VSAM component by creating a new component record, setting the delete time of the original component record, and pointing the new component at the new parent. If the OldParentId is set in the original component, the processor 106 changes the Dataset Id to Old Parent Id and sets the Old Parent Id to NULL.

According to another embodiment, the processor 106 can be configured to monitor SMF records when entities are already active. For example, the processor 106 can create the Jobs Logical Entity 400 which includes a job dataset record when the processor 106 receives an SMF 30 type 1 record. When this occurs, the processor 106 adds an entry to the ActiveJobMap. To prevent an instance in which the processor 106 misses the job start record and may have received a previous SMF record related to the activity of the batch job (e.g., dataset close), the processor 106 can be configured to check the ActiveJobMap for the job, and check the database 104 for an existing active Job using attributes (SysId, Jobname, StartTime). If an active Job does not exist, the processor 106 can create a dummy Job Logic Entity. The details (i.e., attributes) of the dummy Job Logic Entity can be filled in when the processor 106 receives the job end record. Until the job end record is received, the processor 106 creates a dummy step. The processor 106 can update the details and step number of the dummy step upon receipt of the step end record.

If the processor 106 did not miss the Job start record, then an entry will exist in the ActiveJobMap. However, to avoid or mitigate a circumstance in which a step may not have been created, the processor 106 can be configured to check whether the step already exists using Sys Id and Job name in the SMF record and compare these values against Step Created in the ActiveJob. If the step does not exist, the processor 106 can create a new step with a step number that is incremented by an integer value (e.g., 1) over a Current Step Number in Active job. The processor 106 can then increment the Current Step Number in the Active Job and set Step Created to FALSE.

According to another exemplary embodiment, the processor 106 can create the dataset record when an SMF 61 record is received. When this occurs, the processor 106 can add an entry to the ActiveDatasetMap. However, if the processor 106 misses the record receipt of the SMF 61 record, then when any other SMF record that contains dataset information is received, the processor 106 can create dataset records based on the respective content. To avoid or mitigate the result of this operation, the processor 106 can be configured to check the ActiveDatasetMap for the dataset and check the database for a dataset with that name that does not have delete time set. If the dataset does not exist, the processor 106 can create a new dataset row. The processor 106 can update the details of the dataset updated, when a dataset close or dataset delete SMF record is received.

According to yet another exemplary embodiment, the processor 106 can execute an initialization operation in which the Job 500, Step 502 and Event Dataset 504 Logic Entity tables can be prefilled from the existing state of a sysplex. A sysplex is a group of z/OS logical partitions (LPARs) that operate as a single, integrated system, providing high availability, resource sharing, and improved performance through inter-system communication and data sharing services. To perform the prefill operation for the Job and Step Logic Entities 500, 502, the processor 106 queries the System Display and Search Facility (SDSF) for current running jobs and steps. For the Event Dataset Logical Entity 504, the processor 106 can query the Catalog Search Interface (CSI) for existing datasets.

The exemplary embodiments and implementations described herein can enable the migration of IZBR away from VSAM datasets and into a relational database. The embodiments can significantly reduce the complexity of producing new IZBR reports and reengineering existing reports to draw data from the relational database. In addition, the described embodiments and implementations provide interactive user interfaces statistical analysis or perform artificial intelligence (AI) processing using the correlation data between the events and related logical entities. The disclosed embodiments and implementations can also facilitate the generation of more reliable data-contamination recovery plans by IZBR, improving the outcome for customers.

Some of the reports can be complex, and once they have been generated, can be actioned through IZBR. These are typically data contamination recovery plans. The process of generating them usually occurs in multiple phases.

According to an exemplary embodiment, the processor 106 can be configured to perform the method starting from a batch job that failed (or where contaminated data was first noticed) by identifying the datasets that fed into the failed batch job (directly and in directly). The failed batch jobs can be manually examined for signs of contamination, which can result in the identification of a single dataset as the source of the contamination.

The processor 106 can use source dataset to identify the jobs that processed its data (directly and indirectly), which results in a list of potentially contaminated datasets and a list of jobs to rerun.

Once the processor 106 has obtained a list of datasets, the dataset backup records can be evaluated to determine when a time consistent set of backups for these datasets is present. These time consistent sets of backups can be obtained at the end of the previous day's batch processing. The processor 106 can be configured to expand the list of jobs to rerun and datasets to recover to obtain a time consistent set of dataset backups. In one implementation, the processor 106 can generate a signal for performing the recovery operation, or the processor 106 can receive a signal from an external device.

Once the recovery is complete, the contaminated dataset is cleaned, and the processor 106 reruns the identified batch jobs under the control of the customer's batch scheduler product.

Although the reports described herein are referred to as a series of reports by IZBR, they are far from mere trivial pie charts or line graphs that a phrase report typically conjures, and instead, embody significant expert knowledge about the customer's batch processing and dataset backups.

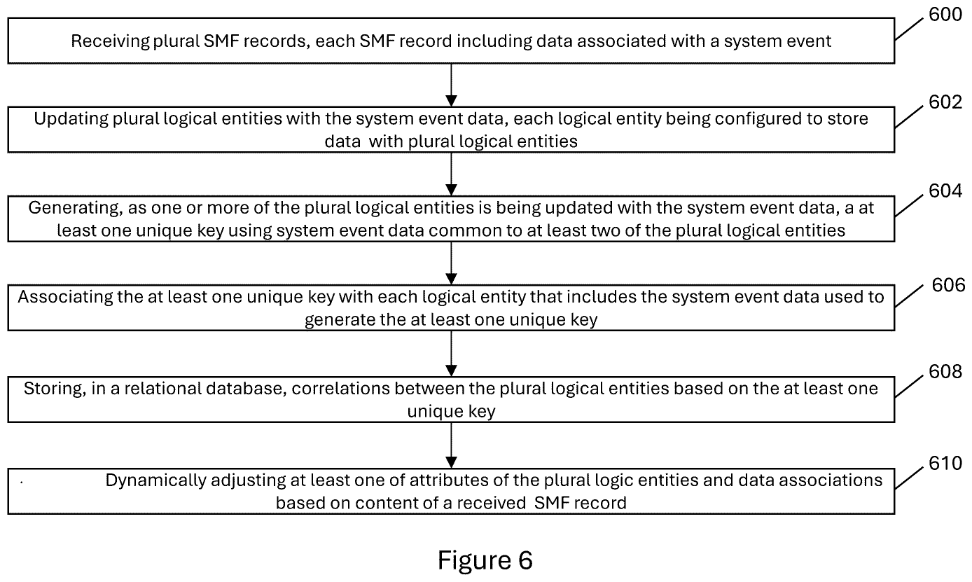

FIG. 6 illustrates a method for mapping System Management Facility (SMF) records to logical entities. The method can be performed by the computing system of FIG. 1 in which the memory 108 stores instructions for mapping SMF records to logical entities, and the processor 106 executes the instructions stored in memory 108 to perform the method. Step 600 of the method includes receiving plural SMF records, each SMF record having data associated with a system event. For example, the system event can include a batch job that is being run. The processor updates plural logical entities 112, 114, 116, 118 with the system event data (Step 602). For example, the plural logical entities can include a Job Logical Entity 500, a Step Logical Entity 502, an Events Dataset Logical Entity 504, and a Dataset Logical Entity 506. The method continues with the processor 106 generating, as one or more of the plural logical entities is being updated with the system event data, at least one unique key using system event data common to at least two of the plural logical entities (Step 604). For example, the unique key 122, 124, 126 is a composite of data that has multiple instances across the plural logical entities 112, 114, 116. In step 606, the processor 106 associates the at least one unique key with each logical entity that includes the system event data used to generate the at least one unique key, and in step 608 stores, in a relational database, correlations between the plural logical entities based on the at least one unique key. The processor 106 dynamically adjusts the stored data of the plural logical entities and data associations based on content of a received SMF record (Step 610).

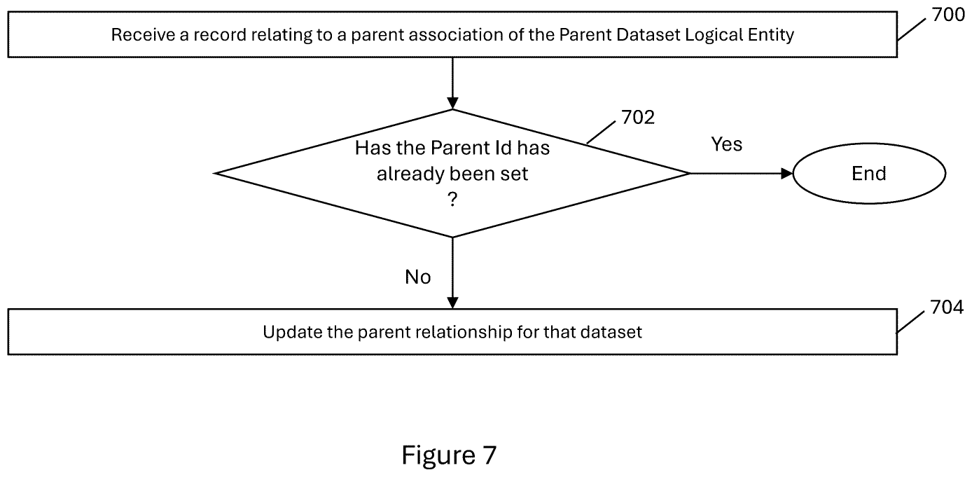

FIG. 7 illustrates a first method of dynamically adjusting the stored data of the plural logical entities. For example, for the Dataset Logical Entity 506, the processor 106 can keep track of VSAM Cluster to VSAM Component associations and GDG Base to GDG part associations based on the Parent Id data value or attribute. In this method, when the processor 106 receive a record relating to a parent association of the Dataset Logical Entity (Step 700), it determines whether the Parent Id has already been set (Step 702). If the Parent Id has been set, no further operations are performed. However, if the Parent Id has not been set the processor 106 updates the parent relationship for that dataset (Step 704).

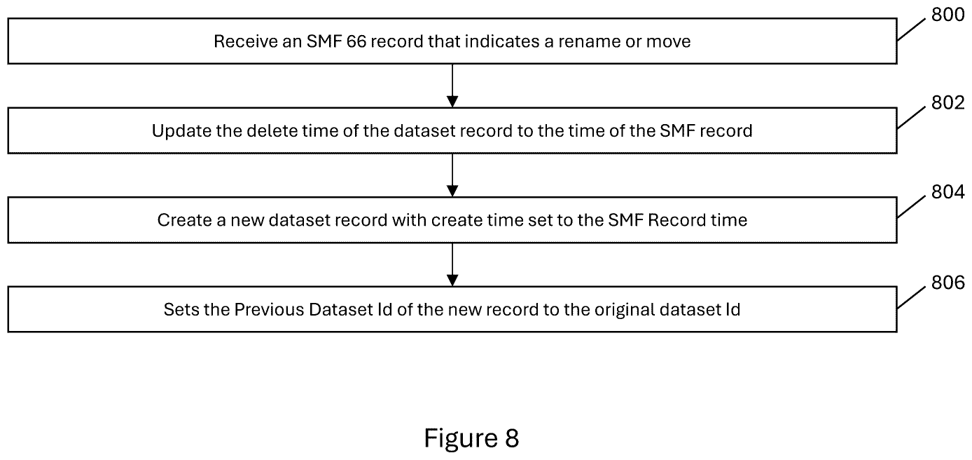

FIG. 8 illustrates a second method of dynamically adjusting the stored data of the plural logical entities. For example, this method can be performed for the Dataset Logical Entity 406. As shown in step 800, the processor 106 receives an SMF 66 record that indicates a rename or move. Next, the processor 106 updates the delete time of the dataset record to the time of the SMF record (Step 802), creates a new dataset record with create time set to the SMF Record time (Step 804), and sets the Previous Dataset Id of the new record to the original dataset Id (Step 806).

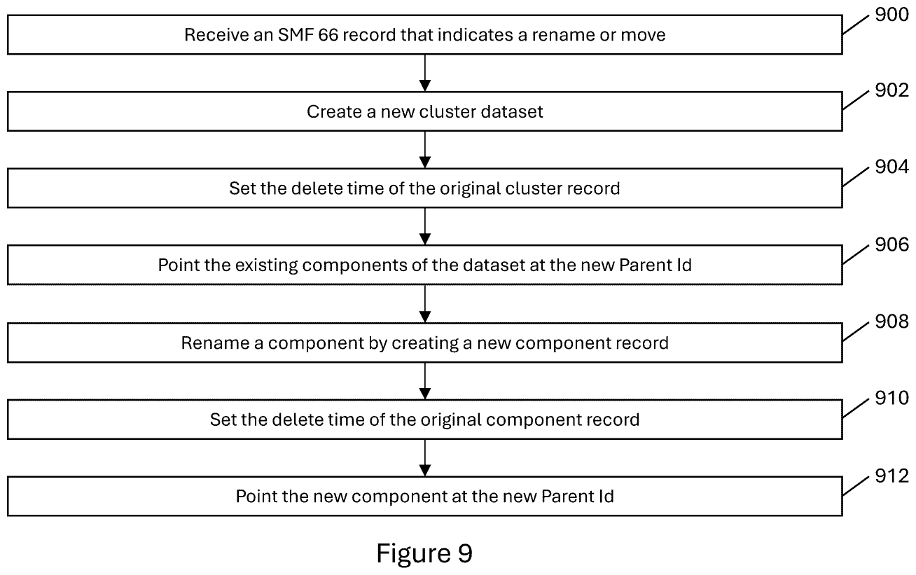

FIG. 9 illustrates a third method of dynamically adjusting the stored data of the plural logical entities. This method is performed by the processor 106 in relation to the Parent Id in the Dataset Logical Entity for changing the VSAM cluster to VSAM component association when a dataset rename is required. In step 900, the processor receives a SMF 66 record and renames a VSAM cluster. Once the cluster is renamed, a new cluster dataset record is created (Step 902). The processor 106 sets the Delete Time of the original cluster record (Step 904) and, in step 906 points the existing components of the dataset at this new parent. Next, the processor 106 renames a VSAM component by creating a new component record (Step 908). In step 910, the delete time of the original component record is set, and in step 912 the processor 106 points the new component at the new Parent Id.

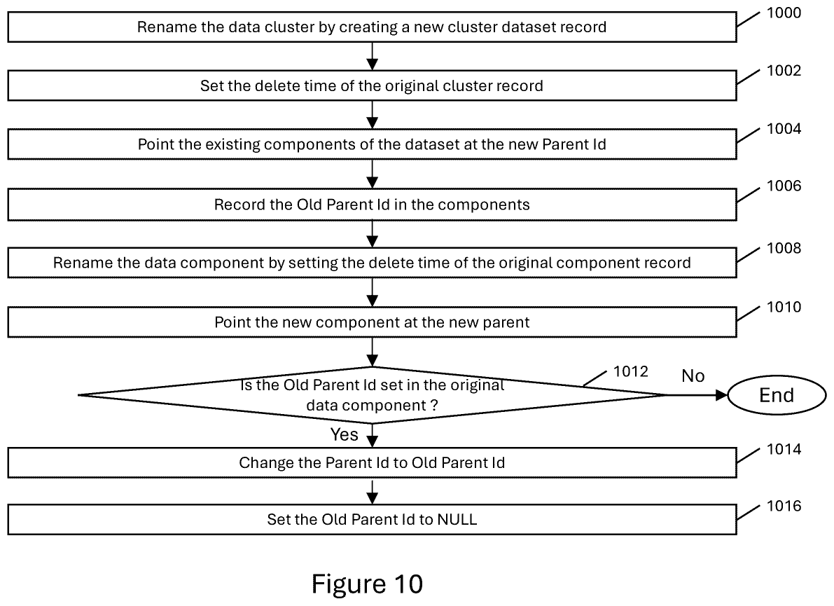

FIG. 10 illustrates a fourth method of dynamically adjusting the stored data of the plural logical entities. This method is performed after the method of FIG. 9 so that the original data component pointing back at the original data cluster. As shown in FIG. 10, the processor 106 renames the data cluster by creating a new cluster dataset record (Step 1000), setting the delete time of the original cluster record (Step 1002), pointing the existing components at this new parent (Step 1004), and recording OldParentId in the components (Step 1006). Next, the processor 106, renames the data component by setting the delete time of the original component record (Step 1008) and pointing the new component at the new parent (Step 1010). The processor 106 determines whether the Old Parent Id is set in the original data component (Step 1012), if the determination is TRUE, the processor 106 changes the Parent Id to Old Parent Id (Step 1014) and sets the Old Parent Id to NULL (Step 1016). If the determination is FALSE, the process ends.

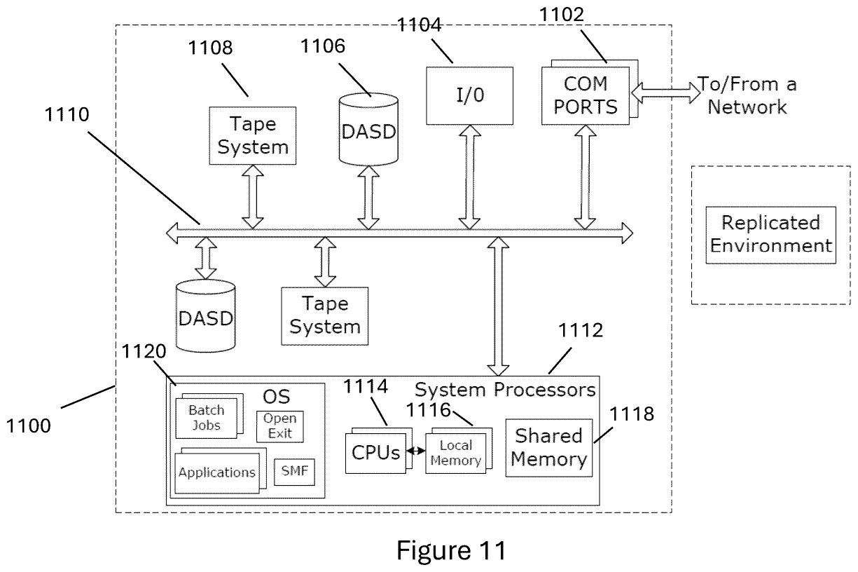

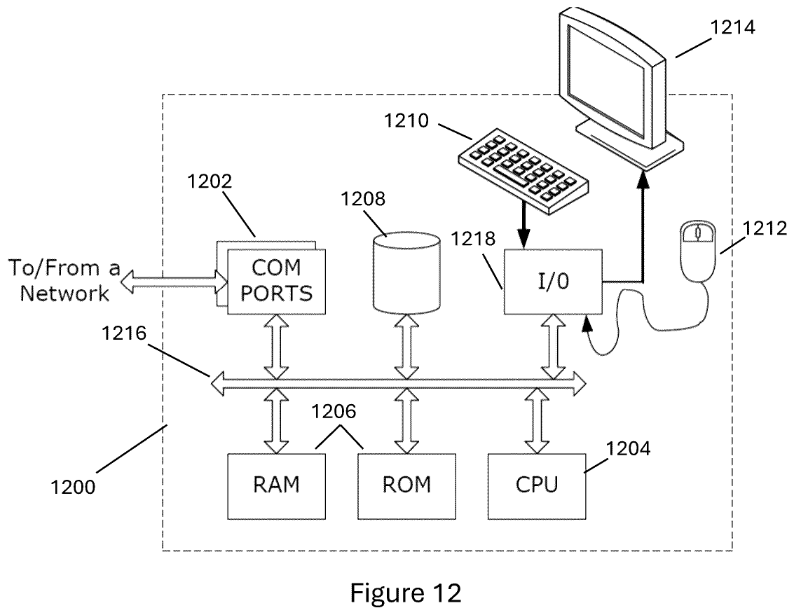

FIGS. 11 and 12 provide functional block diagram illustrations of general purpose computer hardware platforms. FIG. 11 illustrates a network or host computer platform 1100 which can be configured to perform the functions of a server and/or mainframe. FIG. 12 illustrates a computer 1200 with user interface elements, which can be configured to perform the operations of a personal computer or other type of workstation or terminal device. According to another example, the computer of FIG. 12 can be configured via appropriate programming instructions to perform the operations of a server. It is believed that the general structure and general operation of such equipment as shown in FIGS. 11 and 12 should be self-explanatory from the high-level illustrations.

As shown in FIG. 11, a mainframe 1100, for example, includes a data communication interface 1102 for packet data communication and an input/output (I/O) controller 1104. The I/O controller 1104 manages communication to various I/O elements and storage facilities. Storage facilities include one or more direct access storage devices (DASD) 1106 and/or one or more tape systems 1108. Such storage facilities provide storage for data, jobs for managing batch processing and applications. The mainframe 1100 includes an internal communication bus 1110 providing a channel of communication between the communications ports 1102, the I/O controller 1104, and one or more system processors 1112. Each system processor 1112 includes one or more central processing units (CPUs) 1114 and local memory 1116 corresponding to each CPU, as well as shared memory 1118 available to any CPU. An operating system (OS) 1120 executed by the system processors 1112 manages the various jobs and applications currently running to perform appropriate processing. The OS 1120 also provides a system management facility (SMF) and open exit points for managing the operation of the mainframe 1100 and the various jobs and applications currently running. The hardware elements, operating systems, jobs and applications of such mainframes are conventional in nature. Of course, the mainframe functions may be implemented in a distributed fashion on a number of similar platforms, to distribute the processing load, and/or replicated across one or more similar platforms, to provide redundancy for the processing. As such, FIG. 5 also depicts a replicated environment. Although details of the replicated environment are not depicted, such replicated environment typically contains similar components as already described in relation to the primary mainframe of FIG. 5.

As shown in FIG. 12, a computer type user terminal device 1200, such as a PC, similarly includes a data communication interface 1202, CPU 1204, main memory 1206 and one or more mass storage devices 1208 for storing user data and the various executable programs. The various types of user terminal devices 1200 will also include various user input and output elements. A computer, for example, may include a keyboard 1210 and a cursor control/selection device 1212 such as a mouse, trackball, or touchpad; and a display 1214 for visual outputs. The terminal device 1200 can include an internal communication bus 1216 providing a channel of communication between the communications ports 1202, the I/O controller 1218, and one or more system processors 1204. The hardware elements, operating systems and programming languages of such user terminal devices also are conventional in nature.

Hence, aspects of the method described above may be embodied in programming. Program aspects of the technology may be thought of as “products” or “articles of manufacture” typically in the form of executable code and/or associated data that is carried on or embodied in a type of machine readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through a global information network (e.g. the Internet®) or various other telecommunication networks. Such communications, for example, may enable loading of the software from one computer or processor into another, for example, from a management server or host computer such as proxy server into the mainframe platform that will execute the various jobs. Thus, another type of media that may bear the software elements includes optical, electrical and electromagnetic waves, such as used across physical interfaces between local devices, through wired and optical landline networks and over various air-links. As used herein, unless restricted to non-transitory, tangible “storage” media, terms such as computer or machine “readable medium” refer to any medium that participates in providing instructions to a processor for execution.

Non-volatile storage media include, for example, Read-Only Memory (ROM) 616, optical or magnetic disks, such as any of the storage devices in any computer(s) or the like, such as may be used to hold datasets and programs for enterprise applications. Volatile storage media include dynamic memory, such as Random Access Memory (RAM) 618 or main memory of such a computer platform. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge or any other medium from which a computer can read programming code and/or data. Many of these forms of computer readable media may be involved in carrying one or more sequences of one or more instructions to a processor for execution.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

Unless otherwise stated, any and all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

What is claimed is:

1. A system for mapping System Management Facility (SMF) records to logical entities, the system comprising:
a processor; and
memory storing instructions for mapping System Management Facility (SMF) records to logical entities, the instructions causing the processor to be configured to:
receive plural SMF records, each SMF record including data associated with a system event;
update plural logical entities with the system event data, each logical entity being configured to store data with plural logical entities;
generate, as one or more of the plural logical entities is being updated with the system event data, at least one unique key using system event data common to at least two of the plural logical entities;
associate the at least one unique key with each logical entity that includes the system event data used to generate the at least one unique key;
store, in a relational database, correlations between the plural logical entities based on the at least one unique key, and
dynamically adjust at least one data record of the plural logic entities and data associations based on content of a received SMF record.

2. The system of claim 1, wherein the logical entities comprise a job logical entity which stores data associated with a batch job, a step logical entity which stores data on steps performed during the batch job, an event dataset logical entity that stores data associated with the running of the batch job and steps of the batch job, and a Dataset logical entity which stores data about datasets that have existed or currently existing on the system.

3. The system of claim 2, wherein the job logical entity comprises at least one of: a generated job identification (Id), a system Id, a job name, a job number, a job start time, and a job end time.

4. The system of claim 3, wherein the generated job Id is part of the associated unique key.

5. The system of claim 2, wherein the steps logical entity comprises at least one of: a generated job identification (Id), a step number, a step name, a step start time, and a step end time.

6. The system of claim 5, wherein the generated job Id and the step number are part of the associated unique key.

7. The system of claim 2, wherein the events dataset logical entity comprises at least one of: a generated job identification (Id), a step number, an event number, a dataset event open time, a dataset event close time, and a generated dataset Id.

8. The system of claim 7, wherein the generated job Id, the step number, and the event number are part of the associated unique key.

9. The system of claim 7, wherein the generated dataset Id is part of an associated foreign key.

10. The system of claim 2, wherein the Dataset logical entity comprises at least one of: a generated dataset identification (Id), a dataset name, a dataset create time, a dataset delete time, a parent Id, and an old parent Id.

11. The system of claim 10, wherein the generated dataset Id is part of the associated unique key.

12. The system of claim 10, wherein the parent Id and the old parent Id are part of an associated foreign key.

13. The system of claim 10, wherein the parent Id and the old parent Id reference a Virtual Storage Access Method (VSAM) cluster or a generation data group (GDG) base.

14. A computer-implemented method for mapping System Management Facility (SMF) records to logical entities, the method comprising:
storing, in memory of a computer, instructions for mapping SMF records to logical entities;
executing, by a processor of the computer, the instructions stored in memory, the instructions causing the processor to perform the steps of:
receiving plural SMF records, each SMF record includes data associated with a system event;
updating plural logical entities with the system event data, each logical entity being configured to store data with plural logical entities;
generating, as one or more of the plural logical entities is being updated with the system event data, a at least one unique key using system event data common to at least two of the plural logical entities;
associating the at least one unique key with each logical entity that includes the system event data used to generate the at least one unique key;
storing, in a relational database, correlations between the plural logical entities based on the at least one unique key, and
dynamically adjusting at least one of attributes of the plural logic entities and data associations based on content of a received SMF record.

15. A non-transitory computer readable medium storing instructions which causes a computer system to be configured to:
receive plural SMF records, each SMF record including data associated with a system event;
update plural logical entities with the system event data, each logical entity being configured to store data with plural logical entities;
generate, as one or more of the plural logical entities is being updated with the system event data, at least one unique key using system event data common to at least two of the plural logical entities;
associate the at least one unique key with each logical entity that includes the system event data used to generate the at least one unique key;
store, in a relational database, correlations between the plural logical entities based on the at least one unique key, and
dynamically adjusting at least one of attributes of the plural logic entities and data associations based on content of a received SMF record.
